(19) United States
(12) Patent Application Publication
(10) Pub. No.: US 2012/0306962 A1
(43) Pub. Date: Dec. 6, 2012

(54) INKS

(76) Inventor: Marie Holmes, Blackley (GB)

(21) Appl. No.: 13/579,580

(22) PCT Filed: Jan. 26, 2011
(86) PCT No.: PCT/GB2011/050123

§ 371 Date: Aug. 17, 2012

(30) Foreign Application Priority Data
Feb. 23, 2010 (GB) 1003010.4

(51) Int. Cl. B41J 2/17; C09D 11/02

(52) U.S. Cl. 347/20; 106/31.13; 106/18.32; 106/31.48; 106/31.52; 347/84

(57) ABSTRACT

An ink composition comprising:
a) 0.2 to 11 parts diethylene glycol mono alkyl ether;
b) 20 to 45 parts glycerol;
c) 0.5 to 8 parts pentan-1,5-diol;
d) 0.5 to 9 parts colorant;
e) 40 to 70 parts water;
f) 0 to 8 parts 2-pyrollidinone;
g) 0 to 3 parts surfactant;
h) 0 to 5 parts in total of polyalkylene glycol and/or polyalkylene glycol ether having, in each case having a MWT of at least 5,000; and
i) 0 to 5 parts biocide;
   wherein all parts are by weight. Also claimed are ink sets. The inks and ink sets are particularly useful for piezo ink jet printers.

This invention relates to inks and to ink sets and their use in ink jet printing, particularly in the commercial print sector.

Ink jet printing (IJP) is a non-impact printing technique in which droplets of ink are ejected through a fine nozzle onto a substrate without bringing the nozzle into contact with the substrate.

Desktop printers are commonly used in the home and small offices to print, for example, family photographs, children's homework and documents having a small number of pages such as letters.

In contrast the commercial print sector uses larger ink jet printers which are often floor-based. These printers churn out vast quantities of documents such as telephone bills, utility bills, newspapers and books.

The demands placed on printers used in the commercial print sector are quite different from those in desktop. As the commercial printers run continuously for long periods the inks need to be particularly stable and not block the printhead. In contrast to desktop printers, printheads used in the commercial print sector are often positioned in a wide, single array and print substrates in a single pass. Even if even one nozzle becomes blocked this can lead to a blank band on a vast number of documents. In contrast, desktop printers usually have a much narrower printhead and print substrates in multiple passes such that it is less noticeable if a single nozzle becomes blocked.

Ink jet printers in the commercial sector can run at extraordinary speeds, for example the Océ Jetstream™ printers claim to be able to print 600×600 dpi resolution at a speed of 150 metres/min. This imposes technical demands not present on desktop printers producing only a few pages per minute. Increasing print speed often means that the ink jet ink should desirably dry more quickly such that the final print does not smudge when stacked. Inks with a quicker drying time, however, pose an increased risk of the ink drying and crusting over on the nozzles whilst the printer is not actively printing.

The substrates used in the commercial print sector are often much more varied and often quite different from those used in desktop. In the desktop sector, glossy and special coated papers are often used because the cost can be tolerable when printing individual photographs and the occasional short document. However in the commercial print sector, the high volume printing of, for example, utility bills, requires inexpensive substrates such as plain papers, thin paper of the kind used in newspapers and offset media which can be difficult to print effectively with aqueous inks. Customers in the commercial print sector expect inks to be suitable for a wide variety of substrates, from very thin absorbent substrates to substrates with much less absorbency. Thin substrates such as those used in newspapers can suffer from poor dot definition due to “feathering” of the ink across the paper. “Strike through” can also be a problem with conventional inks where the ink permeates right through the thin paper to become visible on the other side. Good drop definition and edge acuity are high priorities in the commercial print sector.

U.S. Pat. No. 4,378,564 discloses IJP inks comprising a dye and a mixture of butyl cellosolve and butyl carbitol.

GB 2,423,995 describes aqueous pigment inks comprising ethylene glycol mono butyl ether, an acrylic binder and optionally diethylene glycol mono butyl ether. There is a need to provide inks with less strike through than those disclosed in GB 2,423,995.

According to a first aspect of the present invention there is provided an ink composition comprising:
a) 0.2 to 11 parts diethylene glycol mono alkyl ether;
b) 20 to 45 parts glycerol;
c) 0.5 to 8 parts pentan-1,5-diol;
d) 0.5 to 9 parts colorant;
e) 40 to 70 parts water;
f) 0 to 8 parts 2-pyrollidinone;
g) 0 to 3 parts surfactant;
h) 0 to 5 parts in total of polyalkylene glycol and/or polyalkylene glycol ether having, in each case having a MWT of at least 5,000; and
i) 0 to 5 parts biocide;
   wherein all parts are by weight.

Preferably the ink has a viscosity of 2.5 to 11 cP, more preferably 3 to 10 cP, especially 3.5 to 9 cP, more especially 4 to 8 cP and particularly 5 to 7 cP. The viscosity may be measured at 32° C. if desired, for example using a Brookfield spindle 18 at 60 rpm. This viscosity is somewhat higher than is typically used for inks intended for desktop use.

Preferably the ink has a surface tension of 20 to 45, more preferably 25 to 40, especially 27 to 38 dynes/cm. The surface tension may be measured at a temperature of 32° C. if desired.

Preferably the ink has a pH of 6 to 10, more preferably 6.5 to 9.5, especially 6.8 to 8.3.

In this specification “parts by weight” is often abbreviated to just “parts” without any change in meaning.

Component a) is preferably present in the composition in an amount of 1 to 11 parts, more preferably 1.5 to 10 parts, especially 2 to 5 parts, more especially 2 to 4 parts.

Component a) is preferably diethylene glycol mono C₁₋₆-alkyl ether, especially diethylene glycol mono butyl ether.

Component b) is preferably present in the composition in an amount of 22 to 41 parts, more preferably 24 to 38 parts, especially 25 to 35 parts, more especially 27 to 33 parts.

Component c) is preferably present in the composition in an amount of 0.8 to 6 parts, more preferably 0.9 to 5 parts, especially 1 to 4.5 parts, more especially 1.4 to 3.6 parts.

The amount of component d) included in the composition will depend to some extent on the intensity of colour required for the ink. Typically however component d) is present in an amount of 0.6 to 8 parts, more preferably 1 to 7.5 parts, especially 1.5 to 7 parts.

Preferred colorants are dyes, especially water-soluble dyes. Acid and direct dyes are particularly preferred and as examples there may be mentioned all of the dyes listed in the Colour Index International.

Preferred yellow colorants are C.I. Direct Yellow 86, 132 and 142 and Acid Yellow 23, especially C.I. Direct Yellow 132.

Preferred magenta colorants are C.I. Acid Red 52, monoazo dyes of Formula (1), and mixtures thereof (whether in free acid or salt form), especially mixtures thereof in a weight ratio of 1:99 to 25:75:

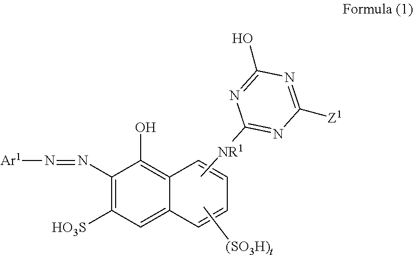

wherein:

Ar¹ is optionally substituted phenyl or optionally substituted naphthyl;

Z¹ is an optionally substituted nitrogen containing heterocyclic group which is attached to the triazine ring by a bond to a nitrogen atom in the heterocyclic group;

R¹ is H or C₁₋₄-alkyl optionally substituted by —OH, —COON or —SO₃H; and

t is 0 or 1.

Preferably Z¹ is an optionally substituted 5- or 6-membered heterocyclic group. It is especially preferred that Z¹ is free from primary or secondary amino groups. More especially Z¹ is morpholino or pyrrolidinyl each of which is optionally substituted by C₁₋₄-alkyl, carboxy or sulpho.

Preferred examples of groups represented by Ar¹ include 2-carboxyphenyl, 3,5-dicarboxyphenyl, 2-sulphophenyl, 3-sulphophenyl, 2-carboxy-4-sulphophenyl, 3,4-dimethyl-6-sulphophenyl, 4-amino-2-hydroxyphenyl, 4-carboxy-2-hydroxyphenyl, 1,5-disulphonaphth-2-yl, 1-sulphonaphth-2-yl, 3,6,8-trisulphonapth-2-yl, 8-hydroxy-2,4-disulphonaphth-1-yl, 1-amino-8-hydroxy-3,6-disulphonaphth-2-yl, 2-amino-8-hydroxy-6-sulphonaphth-1-yl, 2-amino-8-hydroxy-6-sulphonaphth-7-yl, 2-amino-8-hydroxy-3,6-sulphonaphth-1-yl or 6-sulpho-indan-5-yl. It is especially preferred that Ar¹ is phenyl or naphthyl each of which is optionally substituted by one or more of —OH, —SO₃H, —COON, —NH₂, C₁₋₄-alkyl, C₁₋₄-alkoxy or nitro.

When t is 1 the floating sulpho group in Formula (1) is preferably attached at the 3- or 4-position in the naphthalene ring. More preferably t is 1 and the floating sulpho group is attached at the 3-position.

Compounds of Formula (1) may be prepared as described in U.S. Pat. No. 6,635,747.

Preferred cyan colorants are C.I. Direct Blue 86, C.I. Direct Blue 199 and mixtures thereof, especially C.I. Direct Blue 199.

Preferred black colorants are C.I. Direct Black 19, Mobay Black SP, Bayscript Black SP, Steiner Black SP, or of the Formula (2) or (4) (whether in free acid or salt form) and mixtures thereof:

T-Q-N=N-L-T Formula (2)

wherein:

each T independently is an azo group;

Q is an optionally substituted, optionally metallised 1,8-dihydroxynaphthyl group; and

L is a divalent organic linker group; and

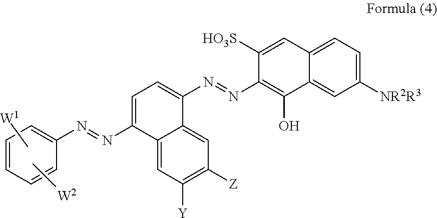

wherein:

W¹ is carboxy;

W² is H, carboxy, sulpho, halo, hydroxy, C₁₋₄-alkoxy or C₁₋₄-alkyl;

Y and Z are each independently H, carboxy or sulpho; and

R² and R³ are each independently H, C₁₋₄-alkyl or C₁₋₄-alkyl carrying a carboxy or sulpho group.

Preferred azo groups represented by T are of the formula A-N═N— wherein each A independently is optionally substituted optionally phenyl or optionally substituted optionally substituted naphthyl. Examples of such groups are listed above for Ar¹.

In Formula (2) L is preferably of Formula (3):

-L¹(-G-L²)ₓ- Formula (3)

wherein:
L¹ is a single covalent bond or optionally substituted phenyl or naphthyl;

L² is optionally substituted phenyl or naphthyl;

G is —O—, —NR⁴—, —N═N—, —NR⁴—CO—, —NR⁴CONR⁴—, —S—, —SO—, —SO₂—, —SO₂NR⁴ or CR⁴═CR⁴—, wherein each R⁴ independently is H or C₁₋₄-alkyl; and

X is 0, 1 or 2.

Preferred optional substituents on A, L, L¹, L² and Ar¹ include halogen (especially F and Cl), nitro, cyano, —CF₃, —OR⁵, —SR⁵, —NR⁶R⁷, —C(O)R⁵, —C(O)OR⁵, —SO₂R⁵, —SOR⁵ or C₁₋₆-alkyl optionally substituted by —OH, —SO₃H, —COOH, —PO₃H₂, C₁₋₄-alkoxy or hydroxy-C₁₋₄-alkylene-oxy;

wherein:

R⁵ is H, C₁₋₆-alkyl optionally substituted by —OH, —SO₃H or —COOH, or phenyl optionally substituted by C₁₋₄-alkyl, —OH, —SO₃H, —COOH, —NH₂ or —NO₂;

R⁶ and R⁷ are each independently H, —CO(C₁₋₆-alkyl), —CONH₂, C₁₋₆-alkyl optionally substituted by —OH, —SO₃H or —COOH, or phenyl optionally substituted by C₁₋₄-alkyl, —OH, —SO₃H, —COOH, —NH₂ or —NO₂; or

R⁶ and R⁷ together with the nitrogen to which they are attached form a 5- or 6-membered ring (preferably morpholine or piperazine).

Especially preferred optional substituents on A, L, L¹, L² and Ar¹ include one or more of C₁₋₄-alkyl, C₁₋₄-alkoxy, —OH, —COOH, —PO₃H₂, —SO₃H, nitro, —Cl, —F, —CF₃, amino and —COOC₁₋₄-alkyl.

Preferably the compound of Formula (4) contains at least as many carboxy groups as sulpho groups.

The black colorant preferably comprises a mixture of dyes are of the Formula (2) or (4), preferably in a weight ratio of 10:90 to 90:10, more preferably 1:2 to 85:15, especially 1:1 to 80:20.

Other black dyes may also be used, either alone or in addition to compounds of Formula (2) and/or (4).

The compounds of Formula (4) may be prepared as described in U.S. Pat. No. 5,203,912.

Component e) is preferably present in the composition in an amount of 44 to 68 parts, more preferably 45 to 63 parts, especially 46 to 61 parts, more especially 50 to 57 parts.

Component f) is preferably present in the composition in an amount of 0 to 7.5 parts, more preferably 1 to 7.2 parts, especially 2 to 7 parts, more especially 3.5 to 6.5 parts.

The surfactant used as component g) may be ionic or, more preferably, non-ionic. Acetylenic glycol surfactants are preferred (especially 2,4,7,9-tetramethyl-5-decyne-4,7-diol), for example Surfynol™ surfactants and especially Surfynol™ 465, 104E and 465 available from Air Products.

Component g) is preferably present in the composition in an amount of 0.001 to 3 parts, more preferably 0.01 to 3 parts, especially 0.1 to 2.5 parts, more especially 0.2 to 1.5 parts.

The polyalkylene glycol and/or polyalkylene glycol ether preferably have a MWT of 8,000 to 50,000, more preferably 10,000 to 40,000, especially 13,000 to 30,000, more especially 15,000 to 25,000.

Preferred polyalkylene glycols and polyalkylene glycol ether comprise poly(ethylene oxide) and/or poly(propylene oxide) groups, especially poly(ethylene oxide) groups.

Poly(ethylene oxide) 15,000 to 25,000 is particularly preferred.

Component h) is preferably present in the composition in an amount of 0.1 to 5 parts, more preferably 0.25 to 4 parts, especially 0.5 to 3 parts, more especially 0.8 to 2.2 parts.

The identity of the biocide is not critical, with Proxel™ GXL being typical of the biocides commonly used in inks. Component i) is preferably present in the composition in an amount of 0.001 to 1.5 parts, more preferably 0.01 to 1 parts, especially 0.01 to 0.3 parts.

In addition to the abovementioned components, the ink composition may optionally comprise one or more ink additives. Preferred additives suitable for IJP inks are pH adjusters and/or buffers, anti-kogation agents, rheology modifiers, corrosion inhibitors and chelating agents and dyes. Preferably, the total amount of all such additives is no more than 10 parts by weight.

In one embodiment the ink is free from pigments. In another embodiment the ink is free from ethylene glycol monobutyl ether. In a further embodiment the ink is free from acrylic binders.

In view of the foregoing, a particularly preferred ink comprises:
a) 1 to 11 parts diethylene glycol mono butyl ether;
b) 22 to 41 parts glycerol;
c) 1.4 to 3.6 parts pentan-1,5-diol;
d) 0.6 to 8 parts water-soluble colorant;
e) 44 to 68 parts water;
f) 1 to 7.2 parts 2-pyrollidinone;
g) 0.001 to 3 parts non-ionic surfactant;
h) 0.1 to 5 parts in total of poly(ethylene) glycol and/or polyalkylene glycol ether, in each case having a MWT of 8,000 to 50,000; and
i) 0.001 to 1.5 parts biocide;
   wherein all parts are by weight. In this ink it is preferred that the viscosity is 3 to 10 cP, the surface tension is 20 to 45 dynes/cm and the pH is 6 to 10.

In view of the foregoing, a particularly preferred ink comprises:
a) 2 to 5 parts diethylene glycol mono butyl ether;
b) 27 to 33 parts glycerol;
c) 0.8 to 6 parts pentan-1,5-diol;
d) 1.5 to 7 parts water-soluble colorant;
e) 46 to 61 parts water;
f) 3.5 to 6.5 parts 2-pyrollidinone;
g) 0.5 to 1.5 parts non-ionic surfactant;
h) 0.8 to 2.2 parts in total of polyalkylene glycol and/or polyalkylene glycol ether, in each case having a MWT of 15,000 to 25,000; and
i) 0.01 to 0.3 parts biocide;
   wherein all parts are by weight. In this ink it is preferred that the viscosity is 4 to 8 cP, the surface tension is 27 to 38 dynes/cm and the pH is 6.8 to 8.3.

The number of parts of a) to i) preferably add up to 100. This is not to say that additional ingredients cannot be present, it merely defines the relative amounts of the specified components relative to one another.

Preferably the inks of the present invention comprise less than 3 parts, more preferably less than 2 parts, especially less than 1 part, more especially is free from ethylene glycol mono butyl ether.

A preferred method for measuring the surface tension comprises the use of a DuNouy ring.

Preferably, the ink composition has been filtered through a filter having a mean pore size of less than 10 microns, more preferably less than 5 microns and especially less than 1 micron.

According to a second aspect of the present invention there is provided an ink set comprising a yellow ink, a magenta ink, a cyan ink and a black ink, wherein each ink independently is as hereinbefore described.

The colorants used in the yellow ink, magenta ink, cyan ink and black ink of the ink set are preferably as described and preferred above in relation to the first aspect of the present invention.

According to a third aspect of the present invention there is provided an ink set comprising a yellow ink, a magenta ink, a cyan ink and a black ink, wherein:
(a) the yellow ink comprises C.I. Direct Yellow 86, C.I. Direct Yellow 132, C.I. Direct Yellow 142, C.I. Acid Yellow 23 or a mixture comprising two or more thereof, especially C.I. Direct Yellow 132;
(b) the magenta ink comprises C.I. Acid Red 52, a monoazo dye of Formula (1 (whether in free acid or salt form) as hereinbefore defined or a mixture thereof, especially mixtures thereof in a weight ratio of 1:99 to 25:75;
(c) the cyan ink comprises C.I. Direct Blue 86 and/or C.I. Direct Blue 199, especially C.I. Direct Blue 199; and
(d) the black ink comprises C.I. Direct Black 19, Mobay Black SP, Bayscrpt Black SP, Steiner Black SP, or a dye of the Formula (2) or (4) (whether in free acid or salt form) or a mixture thereof, especially a mixture of dyes of the Formula (2) and (4) (whether in free acid or salt form) in a weight ratio of 10:90 to 90:10.

The preferred ratios of C.I. Acid Red 52:monoazo dye of Formula (1) and the preferred ratios of dyes of Formula (2):(4) in the ink set of the third aspect of the present invention are as described above in relation to the first aspect of the present invention.

Preferably the inks of the ink set are each independently as described and preferred above in relation to the first aspect of the present invention.

According to a fourth aspect of the present invention there is provided a process for printing an image on a substrate comprising applying an ink according to the first aspect of the present invention or an ink set according to the second or third aspect of the present invention to a substrate by means of an ink jet printer.

The substrate is preferably a paper, a plastic film or a textile material. The paper may be a plain or treated paper, and may have an acid, alkaline or neutral character. Examples of commercially available papers include, Xerox Acid Paper and Xerox Alkaline paper, (available from Xerox); 4 CC paper from Stora Enso (e.g. 130 gsm paper, especially silk), UPM Brite papers (e.g. Chapelle Darblay UPM Brite 63 C, H 42-52 g/m², UPM Brite 65 C, H 42-55 g/m², UPM Brite 68 C, H 45-55 g/m², Kajaani UPM Brite 68 C 48.8-55 g/m², UPM Brite 68 H, G 48.8-60 g/m², UPM Brite 72 C, H, G 48.8-60 g/m², UPM Brite 76 C, H, G 48.8-60 g/m², Schongau UPM Brite 68 C, H 45-55 g/m², UPM Brite 72 C, H 45-55 g/m² and UPM Brite 76 C, H 45-55 g/m² 52 gsm Brite CSWO); and Aero Gloss Sheet papers (e.g. 68 lb/7 pt and 83 lb/9 pt) and Gloss Web papers (e.g. 90 lb T, 100 lb T, 68 lb/7 pt, 73 lb/8 pt and 83 lb/9 pt) from Sappi.

According to a fifth aspect of the present invention there is provided an ink jet printer comprising one or ink vessels each comprising a chamber and an ink according to the first aspect of the present invention or an ink set according to the third or fourth aspect of the present invention, wherein said ink is present in the one or more chambers.

The inks of the present invention are particularly useful for commercial printers, especially piezo ink jet printers. They have a low tendency to block nozzles and are suitable for a wide variety of substrates. Good drop definition can be achieved with a low strike-through rate. This means the inks are suitable even for light and thin substrates.

The invention is further illustrated by the following Examples in which all parts and percentages are by weight unless otherwise stated.

M1 is the dye described in U.S. Pat. No. 6,635, 747, Example 3.

M2 is C.I. Acid Red 52.

Y1 is C.I. Direct Yellow 132.

C1 is C.I. Direct Blue 199.

K1 is the dye described in U.S. Pat. No. 7,056,376, Example 2.

K2 is the dye described in U.S. Pat. No. 5,203,912, Example 2.

Gly is glycerol.

P15 is pentan-1,5-diol.

2P is 2-pyrollidinone.

S465 is Surfynol™ 465, a surfactant from Air Products.

PEG is poly(ethylene glycol) of MW 20,000.

Bio is Proxel™ GXL (a biocide).

BUC is diethylene glycol monobutyl ether.

### EXAMPLES 1 TO 4

Inks 1 to 4 were prepared by mixing the components specified in Table 1 in the number of parts indicated. The colorant column describes the number of parts of the bracketed colorant(s) included and the weight ratio where more than one colorant is included.

TABLE 1

| | | | | | Wa- | | | | |
|---|---|---|---|---|---|---|---|---|---|
| Ink | BUC | Gly | P15 | Colorant | ter | 2P | S465 | PEG | Bio |
| 1 | 3 | 30 | 2.5 | 2.2 (M1:M2, | 54.7 | 5 | 1 | 1.5 | 0.1 |
| | | | | 90:10) | | | | | |
| 2 | 3 | 30 | 2.5 | 2.7 (Y1) | 54.5 | 5 | 1 | 1.2 | 0.1 |
| 3 | 3 | 30 | 2.5 | 3 (C1) | 54.1 | 5 | 1 | 1.3 | 0.1 |
| 4 | 3 | 30 | 2.5 | 6 (K1:K2, | 52 | 5 | 1 | 0.4 | 0.1 |
| | | | | 2:1) | | | | | |

### Results

The properties of the inks 1 to 4 were as shown in Table 2:

TABLE 2

| Ink | Viscosity (cP) | Surface Tension (dynes/cm) | pH |
|---|---|---|---|
| 1 | 6.2 | 32.1 | 7.4 |
| 2 | 5.9 | 35.4 | 7.8 |
| 3 | 6.2 | 32.0 | 7.2 |
| 4 | 6.2 | 32.6 | 8.3 |

### EXAMPLES 5 TO 9 AND COMPARATIVE EXAMPLES 1 TO 3

Inks 5 to 9 and Comparative Inks CE1 to CE3 were prepared by mixing the components specified in Table 3 in the number of parts indicated.

TABLE 3

| | Example | | | | | | | |
|---|---|---|---|---|---|---|---|---|
| Component | CE 1 | Ex 5 | Ex 6 | CE 2 | CE 3 | Ex 7 | Ex 8 | Ex 9 |
| Glycerol | 10 | 20 | 30 | 10 | 15 | 20 | 30 | 40 |
| 2-Pyrollidinone | 5 | 5 | 5 | 5 | 5 | 5 | 5 | 5 |
| Butyl carbitol | 3 | 3 | 3 | 3 | 3 | 3 | 3 | 3 |
| Pentan-1,5-diol | 2.5 | 2.5 | 2.5 | 2.5 | 2.5 | 2.5 | 2.5 | 2.5 |
| Surfynol ™ | 1 | 1 | 1 | 1 | 1 | 1 | 1 | 1 |
| 465 | | | | | | | | |
| PEG 20000 | 1.3 | 1.3 | 1.3 | 1.3 | 1.3 | 1.3 | 1.3 | 1.3 |
| Yellow 132 | 0 | 0 | 0 | 2.7 | 2.7 | 2.7 | 2.7 | 2.7 |
| Blue 199 | 3 | 3 | 3 | 0 | 0 | 0 | 0 | 0 |
| PROXEL ™ | 0.1 | 0.1 | 0.1 | 0.1 | 0.1 | 0.1 | 0.1 | 0.1 |
| GXL | | | | | | | | |

Footnote:
“Ex” means Example and “CE” means Comparative Example.
Surfynol ™ 465 is a surfactant from Air Products.
PEG 20000 is poly(ethylene glycol) having a molecular weight of about 20,000.
Yellow 132 is C.I. Direct Yellow 132.

Blue 199 is C.I. Direct Blue 199.

### Results

In order to assess the likelihood of the ink crusting over and blocking the nozzle of a commercial printer after a period of non-use, the ability of the aged ink to re-dissolve after standing was assessed as follow.

The ink under evaluation was warmed to 40° C. in the open air and maintained at this temperature for 24 hours. The remaining residue (0.2 g) was weighed into a vial of capacity 10 cm³ containing water (2 cm³). The vial was then shaken at a frequency of 120 cycles per minute and the time taken for the residue to re-dissolve was recorded. The test was repeated and the average value recorded. A longer time to re-dissolve indicates a higher likelihood of crusting and nozzle blockage.

TABLE 4

| Example | Time to dissolve (seconds) |
|---|---|
| CE1 | 69 |
| Ex 5 | 47 |
| Ex 6 | 29 |
| CE2 | 29 |
| CE3 | 21 |
| Ex 7 | 15 |
| Ex 8 | 13.6 |
| Ex 9 | 13 |

From Table 4 it can be seen that for a given colorant, the Examples redissolved more quickly than the Comparative Examples, indicating a lower likelihood of blocking nozzles in a commercial ink jet printer.

1. An ink composition comprising:
a) 0.2 to 11 parts diethylene glycol mono alkyl ether;
b) 20 to 45 parts glycerol;
c) 0.5 to 8 parts pentan-1,5-diol;
d) 0.5 to 9 parts colorant;
e) 40 to 70 parts water;
f) 0 to 8 parts 2-pyrollidinone;
g) 0 to 3 parts surfactant;
h) 0 to 5 parts in total of polyalkylene glycol and/or polyalkylene glycol ether having, in each case having a MWT of at least 5,000; and
i) 0 to 5 parts biocide;
wherein all parts are by weight.

2. An ink according to claim 1 having a viscosity of 2.5 to 11 cP.

3. An ink according to claim 1 having a viscosity of 5 to 7 cP.

4. An ink according to claim 1 having a surface tension of 20 to 45 dynes/cm.

5. An ink according to claim 1 having a pH of 6 to 10.

6. An ink according to claim 1 comprising:
a) 1 to 11 parts diethylene glycol mono butyl ether;
b) 22 to 41 parts glycerol;
c) 1.4 to 3.6 parts pentan-1,5-diol;
d) 0.6 to 8 parts water-soluble colorant;
e) 44 to 68 parts water;
f) 1 to 7.2 parts 2-pyrollidinone;
g) 0.001 to 5 parts non-ionic surfactant;
h) 0.1 to 5 parts in total of poly(ethylene) glycol and/or polyalkylene glycol ether, in each case having a MWT of 8,000 to 50,000; and
i) 0.001 to 1.5 parts biocide;
wherein all parts are by weight.

7. An ink according to claim 1 comprising:
a) 2 to 5 parts diethylene glycol mono butyl ether;
b) 27 to 33 parts glycerol;
c) 0.8 to 6 parts pentan-1,5-diol;
d) 1.5 to 7 parts water-soluble colorant;
e) 46 to 61 parts water;
f) 3.5 to 6.5 parts 2-pyrollidinone;
g) 0.5 to 1.5 parts non-ionic surfactant;
h) 0.8 to 2.2 parts in total of polyalkylene glycol and/or polyalkylene glycol ether, in each case having a MWT of 15,000 to 25,000; and
i) 0.01 to 0.3 parts biocide;
wherein all parts are by weight.

8. An ink according to claim 1 wherein component d) comprises C.I. Direct Yellow 86, C.I. Direct Yellow 132, C.I. Direct Yellow 142 and/or C.I. Acid Yellow 23.

9. An ink according to claim 1 wherein component d) comprises C.I. Direct Yellow 132.

10. An ink according to claim 1 wherein component d) comprises C.I. Acid Red 52, a monoazo dye of Formula (1), or a mixture thereof, whether in free acid or salt form: 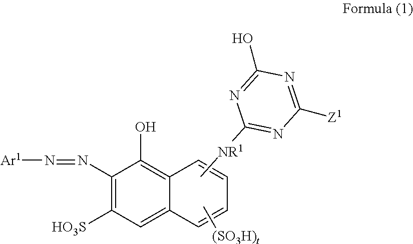
wherein:
A¹ is optionally substituted phenyl or optionally substituted naphthyl;
Z¹ is an optionally substituted nitrogen containing heterocyclic group which is attached to the triazine ring by a bond to a nitrogen atom in the heterocyclic group;
R¹ is H or C₁₋₄-alkyl optionally substituted by —OH, —COOH or —SO₃H; and
t is 0 or 1.

11. An ink according to claim 10 wherein component d) comprises C.I. Acid Red 52 and the monoazo dye of Formula (1) in a weight ratio of 1:99 to 25:75.

12. An ink according to claim 1 wherein component d) comprises C.I. Direct Blue 86, C.I. Direct Blue 199 or a mixture thereof.

13. An ink according to claim 1 wherein component d) comprises C.I. Direct Blue 199.

14. An ink according to claim 1 wherein component d) comprises C.I. Direct Black 19, Mobay Black SP, Bayscript Black SP, Steiner Black SP, or a dye of the Formula (2) or (4), whether in free acid or salt form, or a mixture thereof:
T-Q-N=N-L-T Formula (2)
wherein:
each T independently is an azo group;
Q is an optionally substituted, optionally metallised 1,8-dihydroxynaphthyl group; and
L is a divalent organic linker group; and 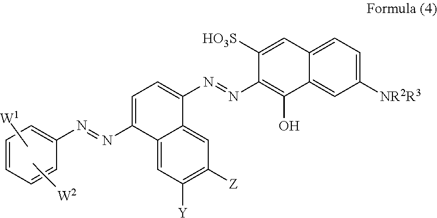
wherein:
W¹ is carboxy;
W² is H, carboxy, sulpho, halo, hydroxy, C₁₋₄-alkoxy or C₁₋₄-alkyl;
Y and Z are each independently H, carboxy or sulpho; and
R² and R³ are each independently H, C₁₋₄-alkyl or C₁₋₄-alkyl carrying a carboxy or sulpho group.

15. An ink according to claim 1 which comprises less than 3 parts of ethylene glycol mono butyl ether.

16. An ink according to claim 1 which is free from ethylene glycol mono butyl ether.

17. An ink set comprising a yellow ink, a magenta ink, a cyan ink and a black ink, wherein:
(a) the yellow ink comprises C.I. Direct Yellow 86, C.I. Direct Yellow 132, C.I. Direct Yellow 142, C.I. Acid Yellow 23 or a mixture comprising two or more thereof;
(b) the magenta ink comprises C.I. Acid Red 52, a monoazo dye of Formula (1), whether in free acid or salt form, as defined in claim 10, or a mixture thereof;
(c) the cyan ink comprises C.I. Direct Blue 86 and/or C.I. Direct Blue 199; and
(d) the black ink comprises C.I. Direct Black 19, Mobay Black SP, Bayscript Black SP, Steiner Black SP, or a dye of the Formula (2) or (4) as defined in claim 14.

18. An ink set comprising a yellow ink, a magenta ink, a cyan ink and a black ink, wherein each ink independently is as defined in claim 1.

19. A process for printing an image on a substrate comprising applying an ink according to claim 1 to a substrate by means of an ink jet printer.

20. An ink jet printer comprising one or more ink vessels, each comprising a chamber and an ink according to claim 1 wherein said ink is present in the one or more chambers.

21. A process for printing an image on a substrate comprising an ink set according to claim 17 to a substrate by means of an ink jet printer.

22. An ink jet printer comprising one or more ink vessels, each comprising a chamber and an ink set according to claim 17 wherein said ink set is present in the one or more chambers.
